(19) United States
(12) Patent Application Publication
(10) Pub. No.: US 2001/0043365 A1
(43) Pub. Date: Nov. 22, 2001

(54) Late binding of tab image contents to ordered tab stock

(75) Inventors: Karl Heinz Kremer, Rochester, NY (US); David R. Hansen, Honeoye Falls, NY (US)

Correspondence Address: BRINKS HOFER GILSON & LIONE, P.O. BOX 10395, CHICAGO, IL, 60610, US

(73) Assignee: Heidelberg Digital L.L.C.

(21) Appl. No.: 09/754,562

(22) Filed: Jan. 4, 2001

Related U.S. Application Data
(63) Continuation-in-part of application No. 09/572,420, filed on May 17, 2000.

(51) Int. Cl. B41B 1/00

(52) U.S. Cl. 358/1.16

(57) ABSTRACT

To allow for the flexibility of printing the tab contents on any one of the tab pages of an ordered tab set, a flag or marker indicating that a page contains a tab plus the information that needs to be rendered on the tab inside the PDF page is stored in memory. This enables the user to move this page around in the document or even copy it to a different document without losing this information. Once the document containing such pages is to be printed, a print output module goes through the PDF document and produces the tabs in the correct locations on the tab pages.

This application is a continuation in part of U.S. Patent Application Serial No. 09/572,420, entitled “Flexible Job Delivery for Job Preparation,” filed on May 17, 2000, which is incorporated herein by reference.

### BACKGROUND

While just about every computer user owns their own printer and is capable of producing high quality documents, the ability to produce such documents in high volume and with special finishing features, such as binding, is still within the purview of the commercial print shops and corporate copy departments. High volume, finished production of documents is typically referred to as production printing. A production printer is a printing device capable of rapid production of large volumes of documents. Typically these printers have high paper handling capacity, the ability to draw on multiple media types from multiple sources and the ability to automatically finish a document such as by adding a binding. Despite the automation provided by the production printer and the proliferation of computer technology, especially in the area of desktop publishing, production printing is still a complicated and often manual process.

In a typical print shop, customers bring in original documents which they want turned into a finished product such as a bound booklet, a tri-fold brochure or a tabbed three ring bound notebook. In addition, they typically need a large volume of the finished product, for example, one thousand brochures. The combination of the original documents plus the instructions for producing the finished product is called a “job”. The documents can be brought in either in hard copy or electronic form, such as on floppy disk, compact disc or tape or can be transmitted to the print shop over a network such as the Internet.

After handing over the documents to the clerk, the customer relays his instructions for preparing the finished product. The clerk will note these instructions on a “ticket” or “job ticket”. The job ticket is typically a piece of paper with all of the instructions written on it for producing the finished product. As mentioned above, this is known as job. The job will then be handed to an operator, who runs the production printer, to produce the finished output. The operator's job is to prepare the document for production, load the appropriate materials, such as paper stock and binding materials, into the production printer and ensure that the finished output is correct.

While the job of the operator seems simple, there are many issues which quickly complicate it. Often, the documents provided by a customer are not ready to be run on the production printer. Some documents provided by a customer are merely raw manuscripts requiring basic formatting, such as margins, typography, etc. Other documents may be formatted but such formatting might not take into account the requested binding. For example, the text of the document is too close to the margin, therefore, when the finished product is bound, some of the text will be obscured. Some documents, such as books, require special care so that, for example, the first page of every chapter appears on the front of a page, also known as imposition. Other forms of imposition include booklet/pamphlet imposition or n-up imposition. Or the customer may bring in multiple documents and ask that these “chapters” be assembled into a book, with a cover and binding.

Other issues which complicate the production printing job are determining and loading the correct media into the production printer. Often, jobs will require many different paper types, such as different stock weights or different colors. In addition, some jobs require the insertion of tab stock at specific points within the document. Still other jobs may require the adding of a bates number or other annotation to the document.

There are many desktop applications that can create documents for printing purposes. However, in some instances, there is also a need to group multiple of these documents, chapters of a single document or combinations of both that are separated by tab sheets for the same printing purposes. These tab sheets often need to be labeled as to reflect the specific subsections defined by the documents or chapter of documents. Often the same desktop application that created the subsection is not capable of creating the tab sheet with its labeling for various reasons (e.g. can't handle the different paper size for the tab sheet).

In a commercial printing environment the subsections are usually delivered to the print shop without tab sheets and/or tab labeling. It is the expectation of both the customer or document creator and the printer that the printer provide the capability to create the tabs and provide a printed document that includes the tabs (with labels) along with the subsections.

In order to print on tabs, the specific tabs need to be created in a separate document and drag and drop them into the appropriate location in the final document. This can be done with the standard configuration of the ImageSmart™. Document Mastering Workstation available from Heidelberg Digital L.L.C., located in Rochester, N.Y., and does not need any special handling of tab pages (besides the fact that the print output module needs to specify the correct paper exceptions for these pages). This can also be done with applications like Microsoft Word®.

In an environment where documents are assembled from pre-created parts, this will cause problems: A customer wants to create user's manuals for machines that is made to order. To accomplish this the documentation department will receive a pick list from manufacturing containing the list of document elements that will make up the complete set of documentation. An example for this would be one customer who orders a Digimaster 9110 available from Heidelberg Digital L.L.C. with just the finisher. This customer would receive only the print engine manual plus the finisher manual. A second customer orders the stacker and the booklet maker in addition to the standard configuration. This customer would therefore receive the documentation for these two parts as well as the basic documentation. Every section of the documentation has a printed tab to make it easier to find in the binder. The tabs contain the name of the sub system that is described in the following chapter. Depending on the number of chapters in the folder the different chapter pages will be printed on different pages of an ordered media set. The tabs need to be aligned with the “order” of the tabs.

In order for the printer to create the printed document with appropriate tabs, the printer needs to take several other variables into account. There are standard tab sheets that come in an “ordered set”. Typically, tab sets are provided in orders of 3, 5, and 7. Additionally, custom tab sets are also available.

When tabs are required for a job, the printer needs to align the number of subsections needing tabs with one of these ordered tab sets, then create the tabs and include this in the printing process. Since, as discussed above, there are multiple ordered tab sets available and the document creator usually does not dictate which ordered set to use (this is usually a “service of the printer”), the printer needs to align the tabs to an order. The printer then fixes the order and creates the specific tab sheets into the document before printing. These tab sheets then become part of the document. The positioning of the tab labels is set since this is based on the tab order.

However, any change of the tab order or tab label alignment necessitates the printer going back and re-working the tab pages in the document. This can be very time consuming for the printer, cutting into his profits for the print job.

It is therefore desirable to have an apparatus and a method for binding the tab information to the ordered tab sheets without having to identify the tab order until just before printing the document. This binding must also be easy and quick, as if just setting another parameter of the print setup.

### SUMMARY

The present invention is defined by the following claims, and nothing in this section should be taken as a limitation on those claims.

To allow for the flexibility of printing the tab contents on any one of the tab pages of an ordered tab set, a flag or marker that indicates that a page contains a tab plus the information that needs to be rendered on the tab inside the page is stored in memory. This enables the user to move this page around in the document or even copy it to a different document without losing this information. Once the document containing such pages is to be printed, a print output module goes through the document and produces the tabs in the correct locations on the tab pages.

In a preferred embodiment, private PDF page objects are used to store this information on a page level. This makes it possible to move the page in one document or copy it to other documents without having to keep track of which pages are printed on tabs.

### BRIEF DESCRIPTION OF THE DRAWINGS

FIG. 1 depicts a flow diagram illustrating a preferred production printing workflow.

FIG. 2 depicts a flow diagram showing the user functionality workflow of the preferred embodiment FIG. 3 depicts a representation of a graphic user interface display according to the preferred embodiment.

### DETAILED DESCRIPTION OF THE PRESENTLY PREFERRED EMBODIMENTS

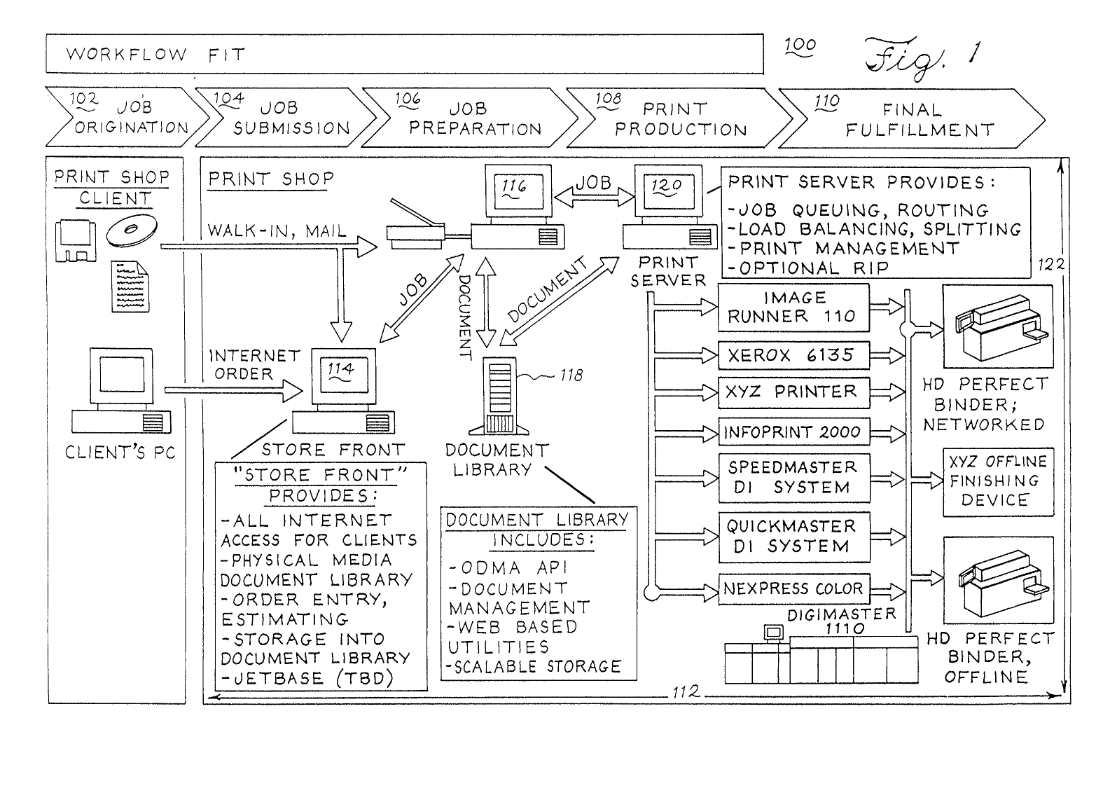

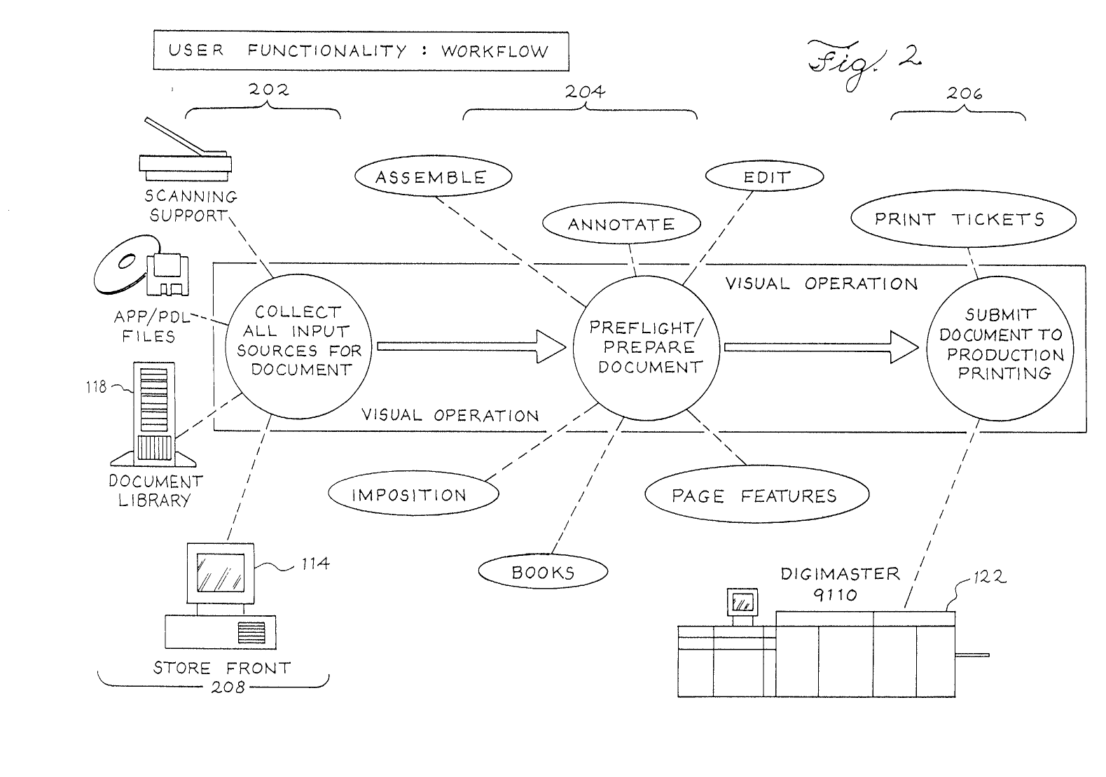

In order to have a better appreciation of the present invention, a discussion of the production flow in a production print shop is provided here. Referring now to FIG. 1, there is shown a flow diagram illustrating the production workflow 100 in a typical production print shop such as a commercial high volume copy or print shop. A workflow is defined as the tasks, procedural steps, organizations or people involved, required input and output information, and tools needed for each step in a business process. As will be discussed below, a workflow approach to analyzing and managing a business or process such as production printing can be combined with an object oriented approach, which tends to focus on the discrete objects and processes involved such as documents, pages, data and databases. For the purposes of this disclosure, the term “object oriented”, when applied to the disclosed embodiments, does not imply that an object oriented programming approach is the only method of implementation of the disclosed embodiments.

FIG. 1 further depicts a typical computer network 112 for use in a print shop. In a typical digital print shop, there will be a network 112 of computer workstations 114, 116, servers 118, 120 and high volume output devices 122 which make up the computer network 112. The servers 118, 120 include network servers 118 and print servers 120. The topology of the network 112 is typically structured so as to align with the workflow 100 of the print shop. The network 112 may be implemented as a wired or wireless Ethernet network or other form or local area network. Further, the network 112 may include wired or wireless connections to wide area networks such as the Internet and connections to other local area networks such as through a virtual private network.

The production workflow 100 includes the procedural stages of job origination 102, job submission 104, job preparation 106, print production 108 and final fulfillment 110. Alternatively, one or more of these procedural stages may be combined as well as there may be other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. Note that a job may contain more than one document and more than one set of instructions. For example, a job may contain many documents, each being one chapter of a book, along with a document containing a cover for the book. This exemplary job may include the instructions for producing the body of the book from the individual chapter documents and another set of instructions for producing the cover. In addition, as will be discussed below, there may be a third set of instructions for assembling the cover to the body of the book.

Job submission 104 is the receipt of the job by the print shop and the entering of the job into the print shops production system or workflow. Typically the instructions from the customer will be written down on a special form, known as a “ticket” or “job ticket”. A ticket may also be electronically created and maintained. Furthermore, pre-defined tickets may be available for standardized instructions. For example, the shop may have a pad of pre-printed tickets with the instructions to duplicate the documents, three-hole punch the final output and assemble the punched final output in a three ring binder. If this is a common request by customers, such pre-printed tickets can save time and resources. All the order taking clerk need do is fill in any customer specific details such as the number of copies to produce. Pre-defined tickets may help to standardize operations and prevent errors in the transcription of instructions from the customer. In very simple print shops, job submission 104 may simply be the receiving of the original documents and instructions along with the creation of a ticket, placing the job in a paper folder and setting it in a physical queue for later handling in subsequent procedural stages.

In print shops which handle jobs electronically, job submission 104 requires entering the job into the shops electronic production system. For documents which are brought in by the customer as hard copy, the documents must first be scanned electronically into the shop's computer system. For documents delivered in electronic form, the document data files must be loaded on the shop's computer system.

For the job submission stage 104, the computer network 112 will include one or more “store front” workstations 114. The store front workstations 114 are computer systems placed at the order taking desk, at a manned clerk's station or set out for customer self service use. These workstations 114 are used for the job submission stage 104 and typically will be configured to handle many different electronic media types such as floppy disk, compact disc, tape, etc. These stations 114 may also be configured to receive jobs over the Internet or other form of network connection with customers. Further, these workstations 114 are typically configured to read many different electronic file formats such as those used by the Microsoft Office™ family of products manufactured by Microsoft Corporation, located in Redmond, Wash. or various other desktop publishing program file formats such as Aldus Pagemaker™ or Quark Express™. In addition, these stations 114 can also read “ready for printer” file formats, which will be discussed later, such as Portable Document Format™ (“PDF”), Postscript™ (“PS”) or printer control language (“PCL”). Job preparation stations 114 can also accept image formats such as Tagged Image File Format (“TIFF”), bitmap (“BMP”) and PCX. These stations 114 may also include a scanner 116 for scanning hard copies of documents into the computer system. Scanners typically are complicated devices to operate and some print shops may prefer to locate the scanners in the job preparation stage 106 for use solely by trained personnel as will be discussed below. In addition, the store front computers 114 also provide the ability to generate a ticket, electronically or in hard copy form, for the job containing all of the instructions for completing the production printing task. This process of generating the ticket may be automated, involving pre-defined tickets, manual or a combination thereof, and is discussed in more detail below.

Job preparation 106 involves preparing the documents for printing according to the instructions in the ticket. For documents that are submitted in hard copy form, job preparation 106 may include scanning the documents and creating a faithful and error free electronic reproduction. The documents, once in electronic form, must also be distilled down or converted into a common file format that the print shop can use to both edit and print the documents. This alleviates the need for operators to deal with multiple different programs and eliminates the need to assemble complex documents together for printing using different electronic file formats.

For example, a customer may bring in two different documents, one being the body of a book and the other being the photographs to be inserted at specific pages. The customer may then instruct that the photographs be inserted at particular pages and that the final assembly has continuous page numbers added. The body of the book may be in Microsoft Word™ format while the images of the photographs are in Adobe Photoshop™ format. While the operator could figure out at which pages the images will be inserted and appropriately number the pages of the book and photographs using each individual software package, this is a very complex and time-consuming process. It also requires that the operator be trained and familiar with a range of software packages and runs the risk that he will not be familiar with the particular package that the customer used. Therefore, it is more efficient to distill each of the various file formats into a unified format which allows the operator to prepare the job using a single software interface. In the preferred embodiments, all documents, whether provided in hard copy or electronically, are distilled or converted into a “ready for printer” or “print ready” file format. In the preferred embodiments, the Portable Document Format™ is used as the ready for printer format, developed by Adobe Systems, Inc., located in San Jose, Calif.

A ready for printer file format is defined as a file format which contains both the data to be printed along with printer control instructions that can be directly interpreted by the internal processing engine of a printer or other form of hard copy output device in order to rasterize the data image onto the output media. Rasterization is the placement of image data at a specific location on the output media. Such file formats include Portable Document Format™ (“PDF”) and Postscript™ (“PS”) both manufactured by Adobe Systems, Inc., located in San Jose, Calif., as well as printer control language (“PCL”), manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the Tagged Image File Format (“TIFF”) contain bit image data only which is already in a format which specifies its output location on the output media and does not contain printer control instructions for interpretation by the internal processing engine of the printer and therefore, for the purposes of this disclosure, is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the operator's expectations.

For the job preparation stage 106, the computer network 106 includes job preparation stations 116 and network servers 118 coupled with the storefront workstations 114 over the network 112. Herein, the phrase “coupled with” is defined to mean directly connected to or indirectly connected with through one or more intermediate components. Such intermediate components may include both hardware and software based components. The job preparation stations 116 preferably execute workflow management software, described in more detail below, which allows the operator to manage, edit and print jobs. The network server(s) 118 includes a document library which allows manipulation, management, storage and archiving of jobs, or just there respective documents and/or tickets, as well as facilitates and manages the flow of jobs from the store front computers 114 to the job preparation stations 116 and from the job preparation stations 116 to the print servers 120 or the production output devices 122. Exemplary document libraries include Intra.Doc™ document management system manufactured by Intranet Solutions, Inc., located in Eden Prairie, Minn. and the DOCFusion document management system manufactured by Hummingbird, Inc., located in York, Ontario, Canada. In the preferred embodiment, the job preparation stations 116 are Imagesmart™ Workstations, manufactured by Heidelberg Digital, L.L.C., located in Rochester, N.Y. Alternatively, an appropriate computer hardware platform such as that comprising a Pentium™ class processor or better, manufactured by Intel Corporation, located in Santa Clara, Calif., 64 megabytes of RAM or more, a 20 gigabyte hard disk or larger and appropriate display device may be used. Further, in the preferred embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, bates numbering, adjusting page layout for tab stock and aligning the output to account for binding. Further, the job preparation stations 114 provide the capability to fix errors in the documents such as removing artifacts in scanned images and masking over unwanted text or markings. The job preparation stations 114 can also be used to prevent inaccuracies in the finished output caused by the printing or binding process. Such inaccuracies include binder's creep which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep is prevented by shifting image slightly when performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet, also known as “n-up” to create proof sets, brochures or pamphlets, etc. Further, the job preparation station 116 permits the operator to add annotations to the document such as bates numbers, page numbers, logos and watermarks. All of these service add value to the final output. Formatting and other modifications to the document can be globally applied to the entire document, such as a shifted margin or may be applied only to select pages. Such alterations to the document are known as document/page features or attributes. Further, these alterations are also known as document or page exceptions since they typically override specific instances of the original document formatting as set by the customer.

The next stage in the print production workflow 100 is the print production stage 108. In the print production stage 108, the final form of the documents for printing is sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIP'ing the job, prior to sending it to a particular device 122. RIP stands for Raster Image Processor and is the hardware and/or software which converts ready for printer data into raster images. It is also a common term for rasterizing a page image on to the output media.

The print server 120 used in the print production stage 108 is coupled with the job preparation stations 116 and the network server 118 over the network 112. Further, the print server 120 is coupled with the various output devices 122 in the print shop. Note that some output devices 122 may not support electronic transfer of the data to be output and may require a manual step for operation. Such devices may include a special binding machine which requires that the partially finished documents be manually transferred to the binding machine to complete the production. The print server 120 is preferably implemented as a separate computer coupled with the network 112, however, software based print servers running on a network server 118, job preparation station 116 or store front workstation 114 may also be used. In the preferred embodiment, the printer server 120 includes an independent computer workstation, typically running a UNIX or Windows NT operating system, a software print server engine and a software print server application. The print server application offers the user interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary output devices include the Digimaster™ Digital High Volume Printer manufactured by Heidelberg Digital, L.L.C., located in Rochester, N.Y. and the NexPress™ Color printer manufactured by NexPress, Corporation, located in Rochester, N.Y.

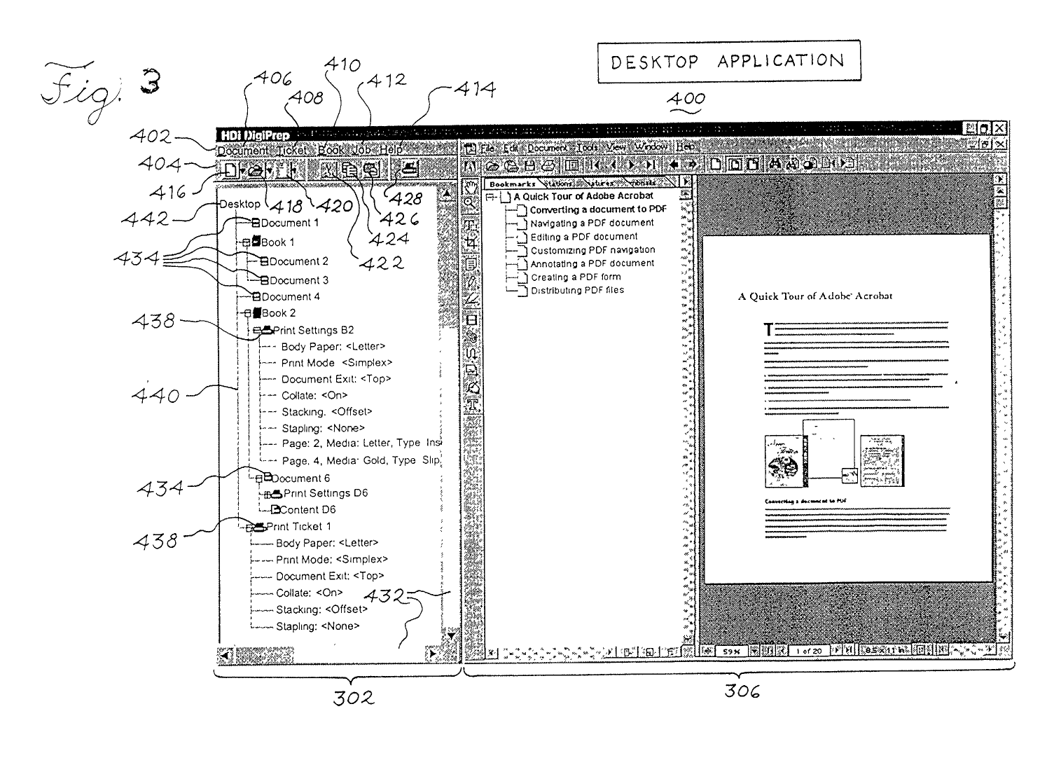

Referring now to FIG. 2, there is shown a flow diagram showing the user functionality workflow 200 of the preferred embodiment job submission and preparation stages 104, 106. The user workflow 200 includes an input source stage 202, a preflight stage 204 and a production stage 206. In the input source stage 202, all of the documents of the job are collected together from the different input sources 208. As detailed above, all of the collected documents are converted to a ready for printer format, preferably a Portable Document Format™. This conversion can be a manual or automated process or a combination thereof. For example, a special directory can be created on the network server 118 where data files in various file formats can be placed, for example, by the clerk who accepts the documents from the customer and inputs them into the store front workstation 114. Automated logic which watches this directory, will see the placement of files and automatically convert them (or flag them for manual conversion) into a ready for printer format. Any documents which the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process may include a manual or automated determination of the capabilities, skill level or training level of the various operators currently logged into the available job preparation stations 116 as well as the current load/backlog of job in their respective queues. Taking these factors into account, job can be automatically or manually routed to the operator best able to handle the job both technically and in an expedient manner. This functionality can be implemented by creating an operator database which tracks the capabilities, skill level and training level of the various operators who work in the print shop. This database can be coupled with queue management software which balances the loads/backlogs of job at each station 116.

In the preflight stage 204, the documents can be assembled, such as in a book, annotated, edited, and have imposition or other page features applied. Once the documents are prepared for production, they are passed to the production stage 206. In the production stage 206, the prepared documents along with the production instructions (from the tickets) are submitted to the print server or directly to the production output device 122 using a file downloader such as the Print File Downloader™ application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

In the preferred embodiments, the user functionality workflow is preferably implemented as a workflow management software program and interface executing on the job preparation workstation 116. The preferred workflow management software is visually oriented using an object oriented graphic user interface (“GUI”) approach which integrates control of the workflow functionality in a single interface. While the visual and operational appearance of the management software is object oriented, the implementation of the software may be by an object oriented programming language or a non-object oriented programming language as are known in the art.

In the GUI interface, documents, tickets and other entities and operations (collectively “objects”) are visually represented on the workstation 116 display, such as with icons, tree structures and pull-down menus, and may be interacted with using known devices and methods such as utilizing a mouse or track ball to control a visually represented pointing device which is then used to click, select, drag and drop the displayed representations. Such manipulation of the visual representations results in manipulation of the underlying objects (documents, tickets, and other entities and operations). Furthermore, the GUI also permits creation and manipulation of relationships and associations among the various objects and visually displays such relationships and associations. Relationships and associations may be displayed, for example, using a hierarchical approach like a tree structure or file folder structure or using some alternate form of visual indication. It will be appreciated that graphic user interfaces are well known in the art and that there are many software development packages available which can be used to develop a GUI. One such package is the Open Software Development Kit available from Microsoft Corporation, located in Redmond, Wash.

Further, the preferred GUI utilizes a document centric approach providing a centralized viewing window for viewing documents being worked on. In the preferred embodiment, the document viewing functionality is provided by the Adobe Acrobat software program, manufactured by Adobe Systems, Inc., located in San Jose, Calif.

As was noted above, the workflow management software integrates applications which implement, control or manage the stages of the production printing workflow 100. These applications include inputting documents from various sources, document assembly including the creation and manipulation of books, document editing, document annotation, document library access on the network server 118, setting and manipulation of page features, creation and manipulation of job tickets and printing.

The workflow management software is capable of receiving input from various different sources. Such sources include hard copy originals input via a scanner, native application formats such as the Microsoft Office™ Product suite and desktop publishing applications such as Quark Xpress™, manufactured by Quark. Inc., located in Denver, Colo. and FrameMaker™, manufactured by Adobe Systems, Inc., located in San Jose, Calif. Further, the software can accept Tagged Image File Format (“TIFF”) documents as well as documents already in a ready for printer format such as PDF, PS or PCL. For hard copy input via a scanner, the software supports industry standard scanner interfaces, TWAIN, as defined by the TWAIN group located in Boulder Creek, Calif. and the Image and Scanner Interface Specification (“ISIS”) developed by Pixel Translations, Inc., located in San Jose, Calif. and also specified via American National Standards Institute specification ANSI/AIIM MS61-1996. Using these standard interfaces, the workflow management software receives the scanned image data directly in the ready for printer format. An exemplary scanner for use with the preferred workflow software is the Imagedirect™ Scanner manufactured by Heidelberg Digital, L.L.C., located in Rochester, N.Y.

The preferred workflow management software also provides ODMA support for interfacing with document libraries. In addition, the provided ODMA support further extends the functionality of the document library to handle management, storage and archiving of compound documents (described below) and tickets. This allows libraries of standardized tickets to be created or facilitates updates and reprints of compound documents such as books.

Once documents are loaded into the workflow management software, tools are provided to perform value added services and prepare the documents for production. Assembly is the process of arranging or rearranging pages or adding or removing pages within a document. Assembly also includes imposition where page positions are forced such as when the first page of a chapter is forced to the front side of the paper. The workflow management software provides cut, copy, paste and move functionality operable on 1 or more pages. This functionality is preferably implemented via pull-down menus, pop up dialog boxes or on screen option palates or buttons as provide by the graphic user interface. In addition, the results of the respective operations are shown in a visual representation of the document in the centralized document viewing window on the job preparation station 116 display.

The workflow management software further provides support for editing and annotating the document. Tools are provided for image object area editing of a scanned page including erase inside and outside an area, cut, move, copy and paste area as well as pencil erase. Page editing tools are also provided for editing on one or more pages including area masking and cropping. Tools are also provided for annotating documents including alpha-numeric and graphic annotations. Exemplary annotations include page numbering and bates stamping. The tools further provide for placing images behind the document content, also known as watermarking. Annotation can be performed on any portion of one or more pages. For alpha-numeric annotations, the font size and style are controllable. In all cases, the results of the respective operations are shown in a visual representation of the document in the centralized document viewing window on the job preparation station 116 display. In the preferred embodiments, edits or annotations can be created or manipulated by pointing to a visual representation of the document and/or pages within the document and selecting, dragging, dropping or clicking the representation and/or selecting from a menu of options, where the selection of a particular option causes the associated edit or annotation to be applied to the specified portions of the document. Alternatively, a palate of options may be displayed from which the user may choose an option to apply to selected portions of the document. Further, the interface may provide for a dialog box or other visual control for inputting control values for the edit or annotation such as the starting number of a bates range.

The workflow management software preferably provides further support for compound documents which are documents comprised of one or more other documents, such as books comprised of chapters or course packs comprised of one or more excerpted sources. Compound documents take advantage of the object oriented nature of the workflow management software. A compound document (“CD”) is a collection of one or more documents which have a particular ordering to them such as the chapters of a book. The CD further contains an automatically generated assembled document which is a single document containing the whole assembled CD. Tools are provided which allow simple management of the documents of a CD, assembly and updating of the documents into the assembled document and selective document manipulation, such as selective printing, of the documents within the CD. Tools are also provided which can interpret the content of the documents within the CD and automatically generate a table of contents in the assembled document. A compound document otherwise acts just like a document and can be edited, annotated, etc. and have tickets associated with it. Further, a compound document can contain other compound documents such as in the case of a multi-volume book. The individual documents and compound documents within the compound document further retain their independent existence and can be edited or printed independently of the CD and shared with other CD's with those edits being either automatically or manually updated into the assembled document within a particular CD. The workflow management software further displays a visual representation, such as with a hierarchical or tree structure, showing the compound document and any associated documents and tickets. In the preferred embodiments, compound documents can be created or manipulated by pointing to the visual representations of one or more documents and/or a visual representation of a CD and selecting, dragging, dropping or clicking and/or selecting from a menu of options, where the selection of a particular option causes the associated feature to be applied to the selected documents or compound documents. Alternatively, a palate of options may be displayed from which the user may choose an option to apply to selected compound documents. Further, the interface may provide for a dialog box or other visual control for inputting control values for the compound documents such as margin values. For example, a user may select one or more documents and then choose a create CD option from a pull down menu. The workflow software then creates a visual representation of the CD on the display showing the association of the CD to the selected documents. Alternatively, the user may first create a visual representation of a CD and then drag and drop the visual representations of one or more documents onto the CD visual representation. The workflow software then creates the appropriate logical associations of the data for which the visual representations represent.

The workflow management software is also preferably programmed with data about the different production output devices 122 in the print shop or otherwise available and their capabilities or other equipment, such as finishing equipment, which can be utilized either automatically or manually. The software provides tools which allow the operator to set page features/formatting which are made possible by those specific capabilities. Such page features include the plex of the document such as duplex or simplex (double sided or single sided output), binding options, such as stapling or hole punching and the availability and control settings for handling tab stock or ordered media. The preferred embodiments preferably support all of the features of the Digimaster™ line of high volume digital printers manufactured by Heidelberg Digital, L.L.C. located in Rochester, N.Y. In the preferred embodiments, these page features can be set by selecting or pointing to a visual representation of one or more pages and selecting from a menu of options, where the selection of a particular option causes the associated feature to be applied to the selected pages. Alternatively, a palate of options may be displayed from which the user may choose an option to apply to selected pages. Further, the interface may provide for a dialog box or other visual control for inputting control values for the feature such as the type of tab stock. Setting page features for specific pages encodes instructions to the production output device 122 for implementing those features within the ready for printer formatted file. When the production output device 122 receives the file for printing, it will interpret those instructions to implement the desired feature. For page features which the current device 122 cannot handle, the device 122 can signal the operator that manual intervention is required and direct the operator through the appropriate steps to implement the page feature and complete the job. This may include instructing the operator to remove partially finished documents and transfer them to a binding machine for finishing or instructing the operator to load a specific media type or tab stock into the device 122.

Tools are further provided by the workflow management software to support electronic versions of tickets for specifying production output device instructions and parameters, as well as other finishing steps which may or may not be automated, which are global to the document, e.g. job level features or global document attributes. These include such attributes as the general media type or color to use and the method of binding such as stapling. Tickets, also referred to as print tickets or job tickets, can exist independently of documents or compound documents as was mentioned above. They are independently visually represented on the display by the workflow management software. Tools are provided for manipulating tickets, such as saving, storing and associating them with documents or compound documents in addition to editing their options. In the preferred embodiments, tickets can be manipulated just like documents, using pointing, clicking, selecting, dragging and dropping. For example, a ticket can be associated with a document by selecting the ticket and dragging and dropping it on a particular document. The workflow management software then preferably visually displays the association by showing the ticket under the hierarchy of the document. Once associated, the options set by the ticket will apply to the associated document or compound document. The options represented by the ticket may be set by selecting the ticket to bring up a dialog box or pull down option menu which displays the available options and allows modification of the option values. Tickets associated with documents can be manipulated with the document. For example, saving a document save all of its associated tickets. Furthermore, the workflow management software provides the capabilities to create libraries of standardized tickets which can be used, for example, to standardize procedures across multiple franchised print shops.

Finally, the workflow management software provides tools to send the prepared documents and any associated tickets to the production output device for final production. In the preferred embodiments, documents or compound documents can be sent to a production output device by selecting, clicking or dragging the visual representation of the document or compound document to a visual representation of the print server or output device. Alternatively, the user may select an appropriate option from a pull-down menu, pop up dialog box or button palate. The workflow management software supports standard interfaces and protocols to production output devices and print servers. Further, tools are provided for managing, selecting and monitoring multiple production output devices. These tools provide visual feed back of each of the devices status to the user such as the current job queues.

Referring now to FIG. 3, there is shown a representation of a graphic user interface display 400 according to the preferred embodiment. The display 400 includes viewer 306 and desktop 302 components. The desktop component 302 includes menus 402 and button palates 404 which allow the user to visually manage and manipulate the various objects described above. The menus 402 include a document menu 406, a ticket menu 408, a book menu 410, a job menu 412 and help menu 414. The button palate 404 includes a new object button 416, an open button 418 and a library access button 420. The button palate 404 further includes a cut button 422, a copy button 424, a paste button 426 and a print button 428. It will be appreciated that graphic user interfaces are well known in the art and there are many ways to implement a GUI and therefore, all forms of graphic input devices, including tear off menus, floating button palates, dialog boxes, alternate keyboard command and mouse short shortcuts and alternative physical input devices are all contemplated.

Further details of the graphic user interface display are provided in U.S. patent application Ser. No. 09/572,420.

As discussed above, many applications require the use of ordered stock or tabs inserted between various sections of a document. Although a customer may know that a tab with certain information is desired between certain sections of a document, the customer usually does not know the particular types or sets of tabs that will be used by the print shop. Therefore, the customer cannot specify the location of the information to be printed on a tab. Moreover, there are situations where documents are assembled from pre-created parts from a customer. For example, if a customer wants to create user's manuals for machines that are made to order the documentation department will receive a pick list from manufacturing containing the list of document elements that will make up the complete set of documentation. An example for this would be one customer who orders a printing system with just the finisher. This customer would receive only the print engine manual plus the finisher manual. A second customer orders a printing system with a stacker and booklet maker in addition to the standard configuration. This customer would therefore receive the documentation for these two parts as well as the basic documentation. The sections of the documentation have a printed tab to make it easier to find them in the binder. The tabs contain the name of the sub-system that is described in the following chapter. Depending on the number of chapters in the folder the different chapter pages will be printed on different pages of the tabs or other ordered media set. The tabs need to be aligned with the “order” of the tabs.

To allow for the flexibility of printing the tab contents on any one of the tab pages of an ordered tab set, the tab content in the present invention is not stored as a regular page of a document. According to the present invention, a flag or marker that indicates that a page contains a tab is stored in memory. Additionally, the information that will be rendered on the tab inside the PDF page is stored in memory. Preferably, the user uses a graphic user interface at a station such as the job preparation station 116 to input the marker or flag upfront in the page or job creating stage. This arrangement enables the user to move this page around in the document or even copy it to a different document without loosing this information. Once the document containing such pages will be printed, the print output module, such as a production output device 122, will go through the PDF document and will produce the tabs in the correct locations on the tab pages. Only the output module therefore has to know about the number of ordered media in one set.

It is also necessary to consider the available space on the tab when creating the document. If at the time of the page creation it is assumed that a set of 5 tabs will be used, but the actual printing is done on 9 tabs the available space is almost cut in half. Private PDF page objects can be used to store this kind of information on a page level. This makes it possible to move the page in one document or copy it to other documents without having to keep track of which pages are printed on tabs.

According to the present invention the print shop operator first assembles all input (electronic and hardcopy) into a single electronic document at the job preparation station 116. In an exemplary embodiment, the Adobe Acrobat software program is used to identify the location of the tab sheets using a utility that works with the same application used to assemble the input (e.g. an Acrobat plug-in). This information is stored with the document. Using a utility that works with the same application used to assemble the input (e.g. an Acrobat plug-in), the tab label information is entered independent from the tab order. This will normally include the text and font. This information is stored with the document. The user then invokes the Print Output Module and identifies the specific stock to use for the tabs. This identifies the order for the tabs. The document is then opened and read through the document starting with the first page through the last. For each tab sheet identified, the tab label information and tab location is taken based on the tab order and the tab sheet is created as an additional page to the document. The amended document is then sent to the printing device as a proof set document. If, after examining the proof set document, the tab order needs to be changed, the printer invokes the print output module and specifies the stock to be used for the tabs and the printer continues through the above steps until the desired output is obtained.

This configuration allows flexibility to align tab content at last possible time (i.e., print time). This preferred configuration also alleviates creator of the document content from needing to know what ordered tab set will be used at print time. This arrangement also eliminates processing overhead on the printer device to create page content first. Also, the present invention obviates the need for the services of a variable data process in the printing device, which could help support the page creation on the printing device end, but adds cost to the printing device and to the application creating the variable data to be sent to the printing device.

It is therefore intended that the foregoing detailed description be regarded as illustrative rather than limiting, and that it be understood that it is the following claims, including all equivalents, that are intended to define the spirit and scope of this invention.

We claim:

1. A printing system for printing a document, said printing system comprising:
a job preparation station, including processor and a memory, said job preparation station generating a flag stored in memory indicating that a selected page in a document to be printed contains a tab, and said job preparation station including an input device for a user to input the marker and information to be rendered on said tab; and
a print output module that receives the flag and information to be rendered on said tab and prints said information on said tab.

2. The printing system of claim 1 wherein the tab flag and tab information are stored as objects.

3. The printing system of claim 2 wherein said objects are page objects.

4. The printing system of claim 3 wherein said objects comprise PDF objects.

5. The printing system of claim 1 wherein a tab sheet is created as an additional page to the document.

6. A printing system for printing a document, said printing system comprising:
a stock input source containing a set of tab stock comprising a plurality of tab stock sheets having tabs at different locations,
a job preparation station, including processor and a memory, said job preparation station generating a flag stored in memory indicating that a selected page in a document to be printed contains a tab;
a user interface including an input device for a user to input the marker and tab label information to be rendered on said tab and to allow a user to select a specific tab stock to be used in the document, the tab label information being entered independent of the tab specific tab stock, wherein the processor creates an additional page to the document as a tab sheet, and the tab sheet contains the tab label information and the location of the tab in the tab set based on the order of the tabs in the set; and
a print output module that receives the flag and information to be rendered on said tab and prints said information on said tab.

7. The printing system of claim 6 wherein the tab flag and tab information are stored as objects.

8. The printing system of claim 7 wherein said objects are page objects.

9. The printing system of claim 8 wherein said objects comprise PDF objects.

10. The printing system of claim 6 wherein a tab sheet is created as an additional page to the document.

11. A method of printing a document on a printing system including a print output module, said method comprising:
generating a flag indicating that a selected page in a document to be printed contains a tab;
inputting a marker and information to be rendered on said tab into the printing system; and
using the flag and information to be rendered on said tab to print said information on said tab on a print output module; and
using said print output module to print said information to be rendered on said tab on tab stock.

12. The method of claim 11 further comprising storing the tab flag and tab information as objects.

13. The method of claim 12 wherein said step of storing comprises storing objects are page objects.

14. The method of claim 13 wherein said step of storing objects as page objects comprises storing objects as PDF objects.

15. The method of claim 11 further comprising creating a tab sheet as an additional page to the document.

16. A method for printing a document on a printing system including a print output module, said method comprising:
providing a set of tab stock comprising a plurality of tab stock sheets having tabs at different locations,
generating a flag indicating that a selected page in a document to be printed contains a tab;
at a user interface inputting a marker and information to be rendered on said tab into the printing system;
using the flag and information to be rendered on said tab to print said information on said tab on a print output module;
selecting a specific tab stock to be used in the document, the tab label information being entered independent of the tab specific tab stock selection;
creating a tab sheet as an additional page to the document, the tab sheet containing the tab label information and the location of the tab in the tab set based on the order of the tabs in the set; and
using the print output module to receive the flag and information to be rendered on said tab and print said information on said tab.

17. The method of claim 16 further comprising storing the tab flag and tab information as objects.

18. The method of claim 17 wherein said step of storing comprises storing objects are page objects.

19. The method of claim 18 wherein said step of storing objects as page objects comprises storing objects as PDF objects.
